(19) United States
(12) Patent Application Publication
(10) Pub. No.: US 2009/0240905 A1
(43) Pub. Date: Sep. 24, 2009

(54) Real-time backup method for single storage medium

(76) Inventors: Ching-Lung Tsai, Hsinchu (TW); Chung-Pin Hsu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,368

(22) Filed: Mar. 18, 2008

(51) Int. Cl. G06F 12/14

(52) U.S. Cl. 711/162; 711/E12.103

(57) ABSTRACT

The present invention provides a real-time backup method for single storage medium which partitions a single storage medium into multiple logic units, and then the logic unit is designated as a backup logic unit or a normal storage logic unit, and the backup logic unit is partitioned into two or more unit blocks. Data with backup demand are simultaneously written into two individual stripe blocks belonging in the two selected unit blocks respectively in the backup logic unit for real-time backup function. Therefore the storage medium is used efficiently and the real-time backup function is achieved.

### BACKGROUND OF THE INVENTION

1. Field of the Invention

The present invention relates to a real-time backup method and in particular to a real-time backup method for single storage medium.

2. Description of the Prior Art

A conventional real-time backup method for single storage medium, referring to FIG. 1, includes a storage medium 10 (e.g. a hard disk) partitioned into two unit blocks 11a, 11b. For example, data are respectively written into strip blocks 111a, 112a and strip blocks 111b, 112b of two unit blocks 11a, 11b at the same time. The data in strip blocks 111b, 112b can be read instead of that in strip blocks 111a, 112a to prevent from reading failure. The conventional method utilizes only half storage medium volume that wastes the storage for the situation of only few backup data.

### SUMMARY OF THE INVENTION

The objective of the present invention to provide a real-time backup method for single storage medium which partitions a single storage medium into multiple logic units, and assigns each logic unit as a backup logic unit or a normal storage logic unit, and partitions the backup logic unit into two or more unit blocks.

Data with real-time backup demand are simultaneously written into two strip blocks belonging respectively to two unit blocks in the backup logic unit to achieve real-time backup function.

When the usage rate of the two unit blocks is full, another two unit blocks are sequentially adopted for backup. In similar way, when the usage rate of the backup logic unit is full, another logic unit is sequentially adopted for storing data, and therefore the usage rate of the storage medium is enhanced.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram showing conventional real-time backup data.

FIG. 2 is a flow chart showing a real-time backup method for single storage medium according to one embodiment of the present invention.

FIG. 3, FIG. 4, and FIG. 5 are schematic diagrams showing real-time backup data for single storage medium according to various embodiments of the present invention.

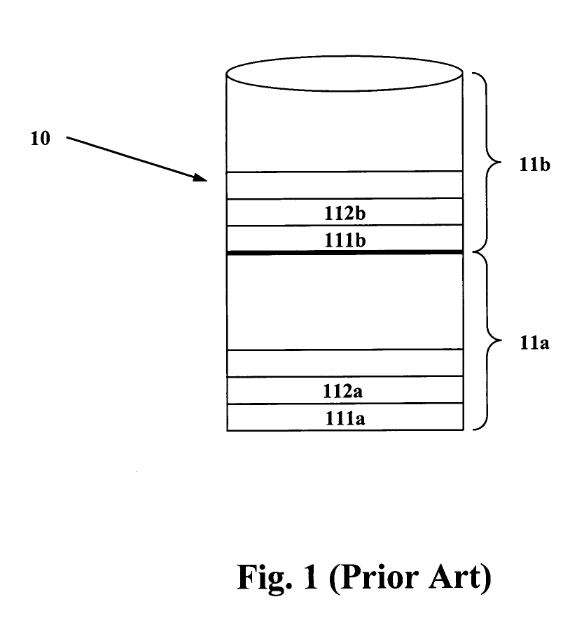

### DESCRIPTION OF THE PREFERRED EMBODIMENT

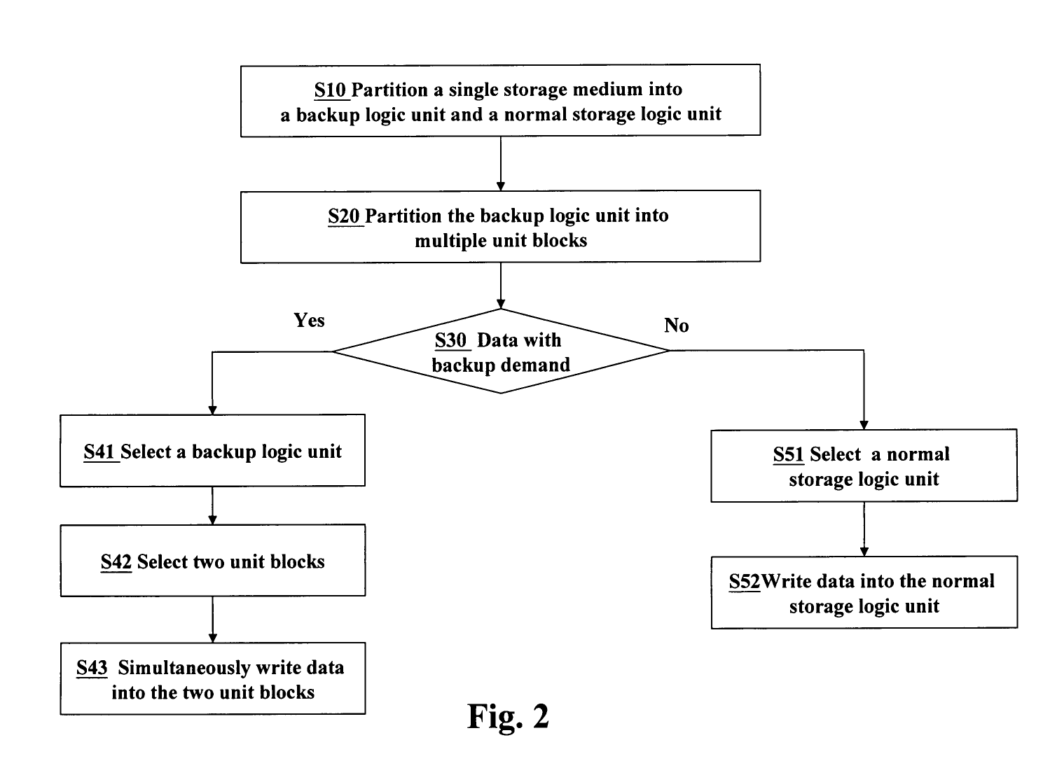

A real-time backup method for single storage medium according to the present invention is disclosed in the FIG. 2. As shown in the figure, a storage medium in the present invention is partitioned into multiple logic units, and each logic unit is designated as a backup logic unit or a normal storage logic unit (step S10). The backup logic unit is partitioned into two or more unit blocks (Step S20). The process of real-time backup should be determined to proceed or not (step S30)—it depends what the data is with or without backup demand. If “Yes”, the backup logic unit is chosen (Step S41), and then two unit blocks are selected, and then the data are written into strip blocks of these two unit blocks in the backup logic unit (Step S43); if “No”, the normal storage logic unit is chosen (Step S51) and then the data are written into the normal storage logic unit (Step S52).

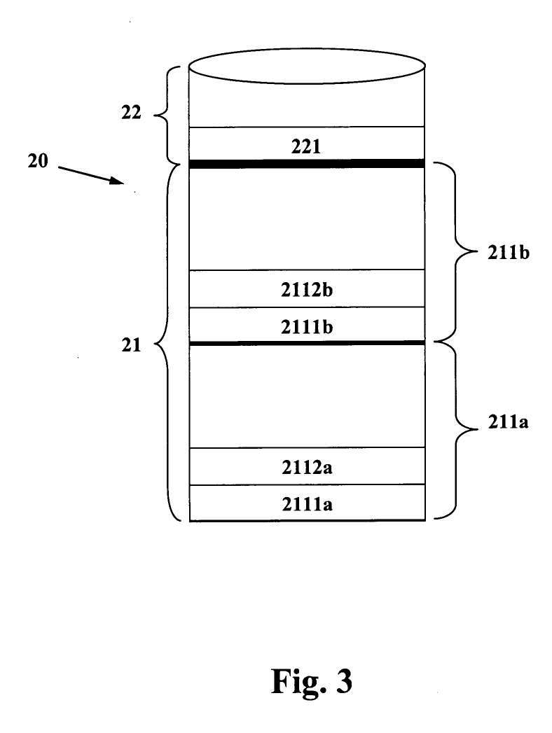

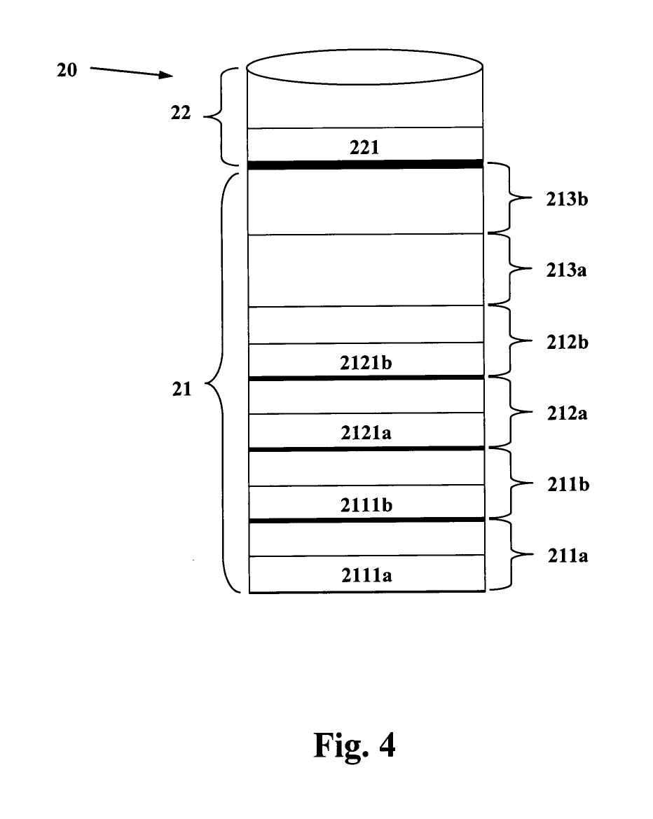

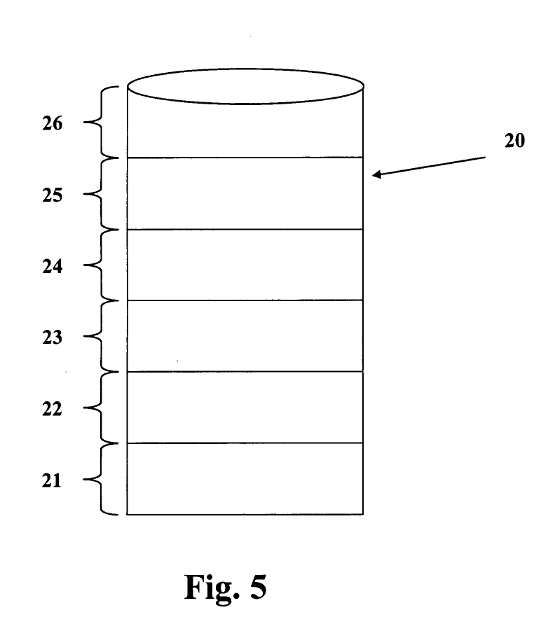

FIG. 3 shows the first embodiment of the present invention. As shown in the figure, a storage medium 20 is partitioned into a backup logic unit 21 and a normal storage logic unit 22, and the backup logic unit 21 is further partitioned into two unit blocks 211a, 211b.

The data with backup demand are simultaneously stored in strip blocks 2111a, 2112a and 2111b, 2112b of two unit blocks 211a, 211b in the backup logic unit 21, respectively, and the data without backup demand are stored in the strip block 221 in the normal storage logic unit 22. The reading process includes reading an address from the backup logic unit 21, selecting a unit block according to the address and reading data from the stripe block of the unit block. When the data stored in the strip blocks 2111a, 2112a are corrupted, the backup data in strip blocks 2111b, 2112b are available.

FIG. 4. shows the second embodiment of the present invention. As shown in the figure, a storage medium 20 is partitioned into a backup logic unit 21 and a normal storage logic unit 22, and the backup logic unit 21 is further partitioned into even numbers of unit blocks 211a, 211b, 212a, 212b, 213a, 213b, and so on.

As the first embodiment shows, the data with backup demand are simultaneously stored in strip blocks 2111a, 2111b of two unit blocks 211a, 211b in the backup logic unit 21, and the data without backup demand are written into the strip block 221 in the normal storage logic unit 22.

What differs from the first embodiment is when the usage of unit blocks 211a, 211b is full, the unit blocks 212a, 212b may be adopted for real-time backup, and unit block 213a, 213b may be sequentially adopted accordingly. The reading process includes reading an address from the backup logic unit 21, selecting a unit block according to the address and reading data from the stripe block of the unit block.

FIG. 5 shows the third embodiment of the present invention. As shown in the figure, a storage medium 20 is partitioned into multiple logic units 21, 22, 23, 24, 25, 26, etc., and the logic units are designated as backup logic units or normal storage logic units.

Those that are designated as backup logic units are further partitioned into two or more unit blocks for real-time backup, as shown in the first or second embodiment, and, in similar way, those that are designated as the normal storage logic units are sequentially adopted for normal data storage when the data storage is full.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A real-time backup method for single storage medium comprising:
partitioning a storage medium into a backup logic unit and a normal storage logic unit;
partitioning the backup logic unit into two unit blocks;
simultaneously writing data with backup demand into two individual stripe blocks belonging in the two unit blocks respectively;
writing data without backup demand into the normal storage logic unit; and
reading data from one of the two unit blocks of the backup logic unit.

2. A real-time backup method according to claim 1, wherein the step of reading data comprises reading an address from the backup logic unit, selecting a unit block according to the address and reading data from a stripe block of the unit block.

3. A real-time backup method for single storage medium comprising:
partitioning a storage medium into a backup logic unit and a normal storage logic unit;
partitioning the backup logic unit into even numbers of unit blocks;
sequentially selecting two unit blocks from the unit blocks;
simultaneously writing data with backup demand into two individual stripe blocks belonging in the two selected unit blocks respectively;
writing data without backup demand into the normal storage logic unit; and
reading data from one of the two selected unit blocks of the backup logic unit.

4. A real-time backup method according to claim 3, wherein the step of selecting two unit blocks is to sequentially select two unused unit blocks if the two unit blocks used currently are full.

5. A real-time backup method according to claim 3, wherein the step of reading data comprises reading an address from the backup logic unit, selecting a unit block according to the address and reading data from a stripe block of the unit block.

6. A real-time backup method for single storage medium comprising:
partitioning a storage medium into multiple logic units;
designating any of the multiple logic units as a backup logic unit or a normal storage logic unit;
partitioning any of the backup logic units into even numbers of unit blocks;
selecting one backup logic unit;
sequentially selecting two unit blocks from the selected backup logic unit;
simultaneously writing data with backup demand into two individual stripe blocks belonging in the two selected unit blocks respectively;
selecting one normal storage logic unit;
writing data without backup demand into the selected normal storage logic unit; and
reading data from one of the two selected unit blocks of the backup logic unit.

7. A real-time backup method according to claim 6, wherein the step of selecting two unit blocks is to sequentially select two unused unit blocks if the two unit blocks used currently are full.

8. A real-time backup method according to claim 6, wherein the step of selecting one backup logic unit is to select an unused backup logic unit if the backup logic unit used currently is full.

9. A real-time backup method according to claim 6, wherein the step of selecting one normal storage logic unit is to select an unused normal storage logic unit if the normal storage logic unit used currently is full.

10. A real-time backup method according to claim 6, wherein the step of reading data comprises reading an address from the backup logic unit, selecting a unit block according to the address and reading data from a stripe block of the unit block.
